(19) United States
(12) Patent Application Publication
(10) Pub. No.: US 2018/0367881 A1
(43) Pub. Date: Dec. 20, 2018

(54) Dual Battery Smart Charge Sharing

(71) Applicant: Apple Inc., Cupertino, CA (US)

(72) Inventors: Robert Zupke, San Francisco, CA (US); Crystal Knodel, San Francisco, CA (US); Jahan Minoo, San Jose, CA (US); Roderick Bacon, Fremont, CA (US); Shiying Zhang, Sunnyvale, CA (US); Lionel Barrow, Oakland, CA (US)

(21) Appl. No.: 15/703,435

(22) Filed: Sep. 13, 2017

Related U.S. Application Data
(60) Provisional application No. 62/520,199, filed on Jun. 15, 2017.

(51) Int. Cl. H04R 1/10; H04R 5/033

(52) U.S. Cl. CPC H04R 1/1025; H04R 2420/07; H04R 1/1066; H04R 5/033

(57) ABSTRACT

Two connected electronic devices may use a controller and two power converters to share battery charge. The two electronic devices may share charge after one electronic device's battery is completely discharged. In the alternative, the two electronic devices may compare the relative age of the two batteries and if the age difference exceeds a predetermined threshold, the younger battery may share charge until it is insufficiently charged to power both electronic devices.

### TECHNICAL FIELD

This disclosure relates generally to the field of battery management and, in particular, to battery charge sharing between two connected electronic devices.

### BACKGROUND

Users of electronic devices may have a number of related electronic devices that are battery powered. In some instances, each electronic device may have its own battery. In such cases, potential differences in battery capacities, loads, etc. may mean that the length of time that the combination of devices may be used is limited by whichever device's battery is completely discharged first. This may be undesirable, as a user might prefer to be able to use remaining capacity in the other battery or batteries to power all of the electronic devices. An additional potentially undesirable effect is that often it will be one device that always discharges its battery first, meaning that over a number of use and charge/discharge cycles, the battery of that device will age more than its counterpart. Thus, it would be desirable to provide a way for multiple related electronic devices to be able to share charge amongst themselves.

### SUMMARY

This disclosure describes a method and apparatus for sharing battery charge between multiple electronic devices. An exemplary apparatus will be discussed to illustrate the necessary components and illustrate one possible embodiment of the invention. In one embodiment, the apparatus is a headphone. Two exemplary methods for choosing when to share battery charge will be discussed to illustrate different considerations and repercussions on the health of the batteries. In one embodiment, the batteries share charge between electronic devices after one battery has been fully discharged. In another embodiment, the batteries share charge between electronic devices until the battery sharing charge is unable to sustain the shared charge any longer.

### BRIEF DESCRIPTION OF THE DRAWINGS

Various embodiments of the disclosed concepts are illustrated by way of example and not by way of limitation in the accompanying drawings in which like references indicate similar elements. It should be noted that references to “an”, “one” or “another” embodiment in this disclosure are not necessarily to the same or different embodiment, and they mean at least one. In order to be concise, a given figure may be used to illustrate the features of more than one embodiment, or more than one species of the disclosure, and not all elements in the figure may be required for a given embodiment or species.

FIG. 1 is the schematic diagram of exemplary headphone 100 in accordance with one embodiment.

FIG. 2 is the flow chart of exemplary method 200 for controlling battery discharge in accordance with one embodiment.

FIG. 3 is the flow chart diagram of exemplary method 300 for controlling battery discharge and slowing battery aging in accordance with one embodiment.

FIG. 4 is the plot of charge over time for exemplary methods 200 and 300.

### DETAILED DESCRIPTION

In the following description, for purposes of explanation, numerous specific details are set forth in order to provide a thorough understanding of the disclosed concepts. As part of this description, some of this disclosure's drawings represent structures and devices in block diagram form in order to avoid obscuring the disclosure. In the interest of clarity, not all features of an actual implementation are described in this disclosure. Moreover, the language used in this disclosure has been principally selected for readability and instructional purposes, and may not have been selected to delineate or circumscribe the disclosed subject matter, resort to the claims being necessary to determine such disclosed subject matter.

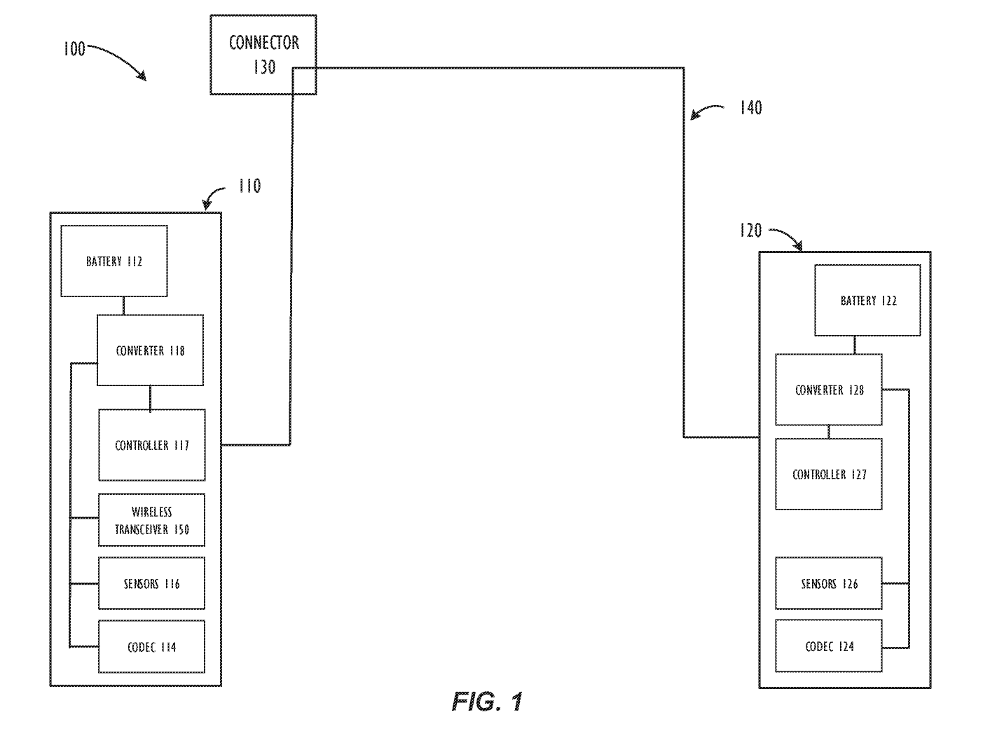

FIG. 1 is a schematic diagram of exemplary headphone 100 in accordance with one embodiment. As shown in FIG. 1, headphone 100 may include two ear cups, ear cup 110 and ear cup 120. Ear cups 110 and 120 may include batteries 112 and 122, power converters 118 and 128, controllers 117 and 127, and various electrical loads. Power converters 118 and 128 may be controlled by controllers 117 and 127, respectively, to power the loads and/or charge the batteries as described in further detail herein. In the illustrated embodiment, controller 117 operates converter 118 to power the loads for ear cup 110 from battery 112. The load for ear cup 110 includes wireless transceiver module 150, sensors 116, and CODEC 114.

Wireless transceiver module 150 may be used to receive audio from an audio source via a wireless connection, e.g., Bluetooth, WiFi, Zigbee, etc. Wireless transceiver may also be a multi-radio system, providing multiple communication links and/or protocols. Alternatively, a wired interface may be the source of audio data. In some embodiments, audio data may be received in encoded form, in which case codec 114 can be used to decode the data into a signal suitable for driving an audio amplifier and speaker (not shown). Sensors 116 may include any of a wide variety of sensors that would be useful for headphone operation, including, for example, accelerometers and capacitive sensors that can be used to detect whether a user is wearing the headphones and in what orientation they are being worn (e.g., whether ear cup 110 is on the user's left ear or right ear). Other types and numbers of sensors may be provided, and in applications other than an earphone, sensors of entirely different types may be provided.)

As with controller 117, controller 127 operates converter 128 to power the loads for ear cup 120, which loads can include sensors 126 and CODEC 124. The sensors and codec may operate as described above; or, in other embodiments or types of devices, the loads may include more, fewer, or different types of components. In any case, assuming that the batteries 112 and 122 have equal capacities and start with equal states of charge, and because the load for ear cup 110 is greater than the load for ear cup 120, one might expect that battery 112 will be fully discharged before battery 122. (In some embodiments, the headphone may be designed so that the batteries have the same rated capacity, the same form factor, or both. In other embodiments the batteries may be asymmetric with respect to rated capacity and/or form factor.) Alternatively, for other reasons battery 122 may fully discharge before battery 112. In either case, fully discharged does not necessarily mean that every last quantum of charge has been extracted from the battery, rather that the battery has discharged to a point that a battery monitoring unit or other charging system control component (not shown) has determined that it is no longer appropriate to further discharge the battery.

Ear cup 110 and ear cup 120 may be connected though connection 140. Connection 140 may provide for signal communication between the various components located within the ear cups. Additionally, connection 140 may include a current path between converter 118 and converter 128 such that electrical power may be communicated between ear cup 110 and ear cup 120. In the headphone 100, connection 140 may be contained within a headband of the earphone. Additionally, connector 130 may be provided. Connector 130 can provide for external connections, including an analog or digital audio input for the headphones, a power connection for charging batteries 112 and 122, and other required signals. Connector 130 may be integral with the headband, which contains connection 140, or may be integral with one or both of the ear cups 112, 122. In some embodiments, a backup battery (not shown) may be incorporated into the headband. The backup battery could be used to power some or all of the electrical loads upon depletion of batteries 112 and/or 122.

Within each ear cup, for example ear cup 110, battery 112 may supply power to the various loads (e.g., wireless transceiver module 150, sensors 116, and codec 114) through power converter 118. Power converter may be implemented using a variety of power converter technologies, including linear regulators, buck converters, boost converters, buck-boost converters, etc. The specific topology for converters 118 and 128 may be chosen based on the particular voltages and power levels required for the various loads, as well as the voltage and capacity of the battery. Converters 118 and 128 may also be a bi-directional converters, so that in addition to powering the loads, they can also accept power from connector 130 (e.g., via connection 140) to charge batteries 112 and 122. As an alternative, converters 118 and 128 may be used to power the loads from their respective batteries, and a separate converter or converters, not shown, may be used to charge the batteries. In some embodiments, converter 118 (and converter 128) may be bi-directional converters capable of performing buck and boost power conversion.

As mentioned above, in some cases battery 112 may be fully discharged before battery 122 (or vice versa). Thus, the effective use time of the combined device is limited by the battery 112 (or, more generally, the first battery to discharge, which is a function of the batteries' respective capacities, states of charge, load, etc.). One way to address this issue is to selectively control the way the converters power the loads in each ear cup. For purposes of the following example, it will be assumed that battery 112 has fully discharged first, and it is desired to power the loads in both ear cups 110 and 120 from battery 122 in ear cup 120. (It will be understood that the reverse could also apply, i.e., battery 122 could be the first to completely discharge.)

In this example, when controller 140 determines that battery 112 has been fully discharged, controller 117 may communicate with controller 127, located in ear cup 120, requesting that controller 127 operate converter 128 to deliver power via the connection 140 to converter 118, located in ear cup 110. Such communication may take place via a wired link through the headband or via the wireless transceiver (which would necessitate a second wireless transceiver (not shown) in ear cup 120). Controller 117 may then also operate converter 118 to deliver the power thus received to the loads in ear cup 110. In some embodiments, converter 118 may be able to directly pass the received voltage to the loads, while in other embodiments, further conversion (e.g., bucking or boosting of the voltage) may be required. Additionally, converter 118 could operate to charge battery 112 using the power received over connection 140, although this may introduce inefficiencies rendering direct powering of the loads in ear cup 110 from the power received over connection 140 more desirable.

As an alternative to the foregoing, controller 117 may communicate with controller 127, located in ear cup 120, requesting that controller 127 operate converter 128 to deliver power via the connection 140 to the loads in ear cup 110 directly, bypassing converter 118. In other embodiments, controller 117 may communicate with controller 127 requesting that controller 127 couple battery 122 voltage to connection 140, allowing converter 118 to be operated to power the loads in ear cup 110 from battery 122 located in ear cup 120. It will be appreciated that either of these arrangements would be facilitated by suitable electrical connections between ear cups 110 and 120.

Reciprocal operation is also possible, in which case controller 127 may determine that battery 122 has been fully discharged and communicate with controller 117, located in ear cup 110, requesting that controller 117 operate converter 118 to deliver power via the connection 140 to converter 128, located in ear cup 120. Controller 127 may then also operate converter 128 to deliver the power thus received to the loads in ear cup 120. In some embodiments, converter 128 may be able to directly pass the received voltage to the loads, while in other embodiments, further conversion may be required. Additionally, converter 128 could operate to charge battery 122 using the power received over connection 140, although this may introduce inefficiencies rendering direct powering of the loads in ear cup 120 from the power received over connection 140 more desirable. As above, converter 118 may be operated to deliver power via the connection 140 directly to the loads in ear cup 120, bypassing converter 128; or controller 117 may couple battery 112 to connection 140 allowing converter 128 to power the loads in ear cup 120 from the battery 112 located in ear cup 110.

As described in the preceding two examples, coordination of power sharing between the two ear cups was coordinated by a cooperation negotiation between the controllers 117 and 127. The required coordination and communication may take place using any of a variety of links, including wired links, such as a serial data link passing through connection 140, or by wireless links, such as Bluetooth, etc. In the latter case additional components, such as an additional wireless transceiver module (not shown) in ear cup 120 might be required. Additionally or alternatively, and additional controller (now shown) could be provided that is in communication with both controller 117 and controller 127 and directs each to power their respective loads, or to send power across connection 140 as required. Such additional controller (now shown) could be located in either ear cup, in the headband, in the device to which headphone 100 is connected via wire or wirelessly (such as a media player, mobile telephone, tablet computer, laptop computer, desktop computer, etc.).

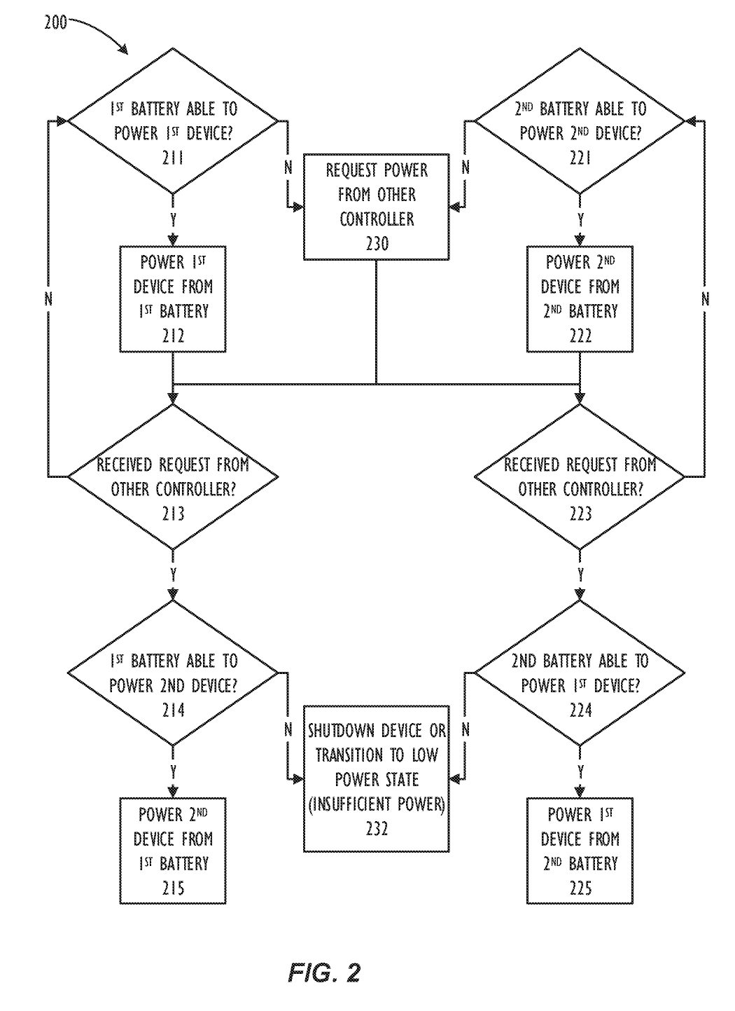

FIG. 2 is a flow chart illustrating an exemplary method 200 for controlling battery discharge in a device like that illustrated in FIG. 1. Operations on the left side of FIG. 2 may be performed by the controller in a first electronic device, such as controller 117 in first ear cup 110. Operations on the right side of FIG. 2 may be performed by a controller in a second electronic device, such as controller 127 in ear cup 120. Operations in the central portion of FIG. 2 may be performed by both controllers acting in concert. As an alternative, all operations could be performed by a central controller (not shown in FIG. 1).

Beginning in block 211, it is determined whether the first battery 112 is able to power the first electronic device (e.g., loads 114, 116, and 150). If so, control passes to block 212 in which the first battery 112 is used to power the first electronic device. If not, control passes to block 230 in which power is requested from the second controller 127. As discussed above, these operations may be performed by controller 117, or by a central controller. Further processing will be discussed in greater detail below. Similarly, in block 221, it is determined whether the second battery 122 is able to power the second electronic device (e.g., loads 124 and 126). If so, control passes to block 222 in which the second battery 122 is used to power the second electronic device. If not, control passes to block 230 in which power is requested from the first controller 117. As discussed above, these operations may be performed by controller 127, or by a central controller.

If one of the controllers 117 or 127 (or, in an alternative embodiment, the central controller) requests power from the other controller in block 230, control passes to block 213 or 223, depending on which controller is requesting power from the other side. For example, if controller 117 requests power from controller 127, in block 223 controller 127 will determine that power has been requested and will (in block 224) make a determination whether second battery 122 is able to power the first electronic device. If so, controller 127 will operate its converter 128 to transfer power to converter 118 corresponding to controller 117, resulting in powering of the first electronic device from the second battery 122 (block 225). Conversely, if controller 127 requests power from controller 117, in block 213 controller 117 will determine that power has been requested and will (in block 214) make a determination whether second battery 122 is able to power the second electronic device. If so, controller 117 will operate its converter 118 to transfer power to converter 128 corresponding to controller 127, resulting in powering of the second electronic device from the first battery 112 (block 215). If, in either case, the side receiving the request for power from the other side has insufficient power (block 214 or 224) then control will pass to block 232, where the device can be shut down or put into a lower power state to conserve its remaining battery charge.

In some embodiments, a first electronic device (e.g., ear cup 110) and a second electronic device (e.g., ear cup 120) may have similarly sized batteries but different loads. In those cases, one might expect that one side (i.e., the side with the greater load) will often, if not usually or always, discharge its battery first, resulting in the first electronic device always drawing power from the second electronic device. If a user were to always completely discharge both batteries before recharging, then both batteries would accumulate charge/discharge cycles at the same rate and would therefore age at the same rate. However, in practice, users may recharge before the batteries are both completely discharge. Repeated cycles of this nature will result in the first battery (for example) cycling/aging at a faster rate than the second battery. This accelerated aging of the one battery may be undesirable.

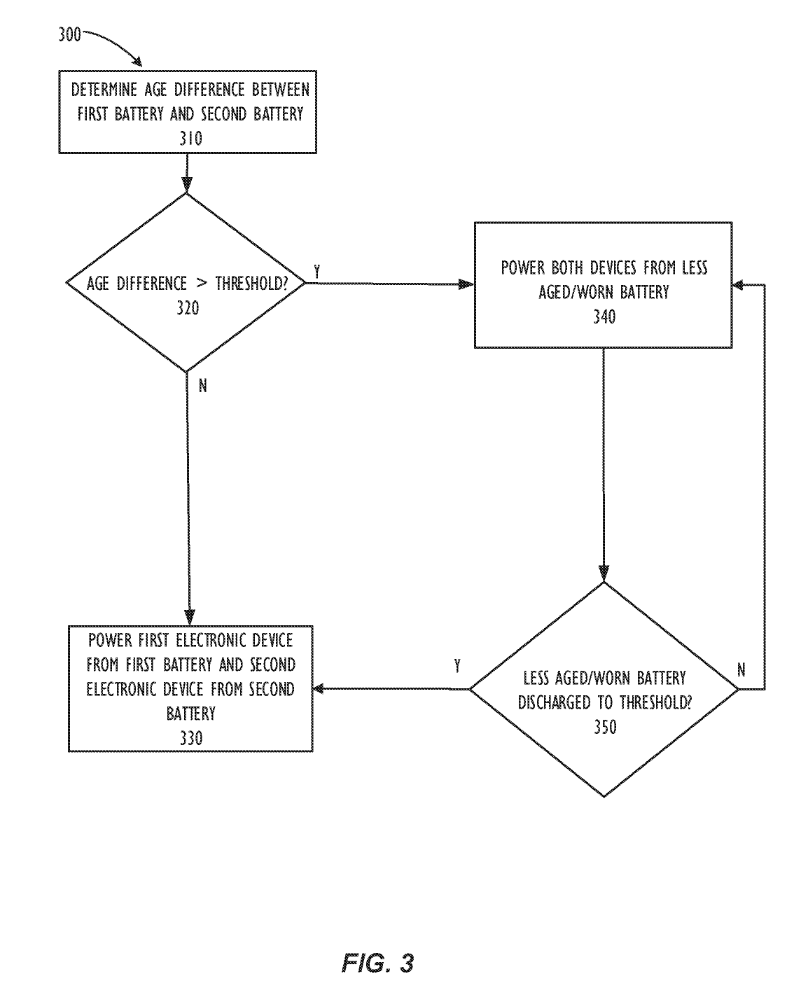

FIG. 3 is a flow chart illustrating an exemplary method 300 for controlling battery charge and discharge cycles to equalize cycling, wear, and aging as between two batteries. The method may be performed by a controller in the electronic devices, for example, controller 117, controller 127, controllers 117 and 127 acting in concert, or another controller not shown. In general, the process operates by determining an age difference between the two batteries. For example, a cycle count may be ascertained for each battery, and a difference in the cycle count may be used as an indication of the relative wear or aging of the batteries. Alternatively, in a case where the batteries started out with the same design capacity, a present full charge capacity may be calculated for each battery, and these present full charge capacities may be compared to determine a difference in the relative wear or aging of the batteries. In a similar vein, comparing the present full charge capacity of each battery with its design capacity may also be used as an indicator of battery wear or aging. Further details of the method may be understood with reference to the figure as discussed below.

Beginning at step 310, an age difference between the first and second batteries may be ascertained. As discussed above, the age difference between the first and second batteries may be found by comparing the present full charge capacities of the first and second batteries, by comparing the cycle counts of the first and second batteries, or by some other suitable technique. Next, in step 320, it is determined whether the determined age difference is greater than a predetermined threshold. If the age difference is less than the predetermined threshold, meaning that the batteries are wearing or aging at about the same rate, control passes to step 330, in which the system powers the first electronic device from the first battery and the second electronic device from the second battery as described above with respect to FIG. 2. In other words, provided each battery has sufficient capacity to power its respective load, then the device operates in that fashion. If one or the other battery lacks sufficient capacity to power its respective load, then both devices are powered from the battery having sufficient capacity. Once neither battery has sufficient capacity to power both loads, the device can be shut down or put into a lower power state to conserve remaining battery charge.

Alternatively, if at step 320 it is determined that the age difference between the two batteries is greater than the predetermined threshold, meaning that the batteries are not wearing or aging at the same rate, control passes to step 340, in which both devices are initially powered from the same battery. More specifically, both devices are powered from the less aged or worn battery so as to increase the cycle count on less aged or worn battery without increasing the cycle count on the more aged or worn battery. In some cases, the user may charge the batteries again before the less aged or worn battery is fully discharged. If so, the method can start again from block 310. If not, in block 350, it can be ascertained whether the less aged or worn battery has been discharged to some predetermined discharge threshold. If not, the system can continue to power both devices from the less aged or worn battery. If so, control passes to block 330, and the system may switch to powering both devices from their respective batteries. Alternatively, if the discharge threshold for the less used or worn battery was a completely discharged state, then both loads may be powered from the more aged or worn battery as described above with respect to FIG. 2.

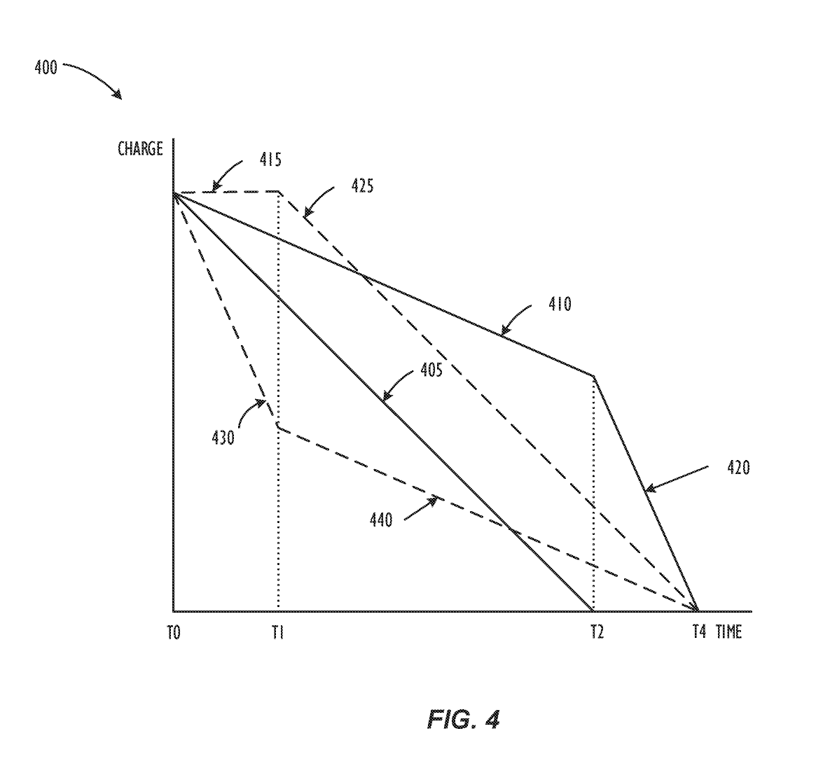

The discharge threshold described above may be selected in a variety of ways. For example, the discharge threshold may be a point where the less aged or worn battery no longer has sufficient charge to power both loads. If so, when the discharge threshold is reached, the system will switch to powering both loads from the more aged battery. As an alternative, the discharge threshold may be selected as a state of charge in which the run time of the less aged or worn battery powering its respective load will equal the run time of the more aged or worn battery powering its respective (e.g., higher) load. (This type of threshold is described below with respect to FIG. 4.) Other discharge thresholds may also be selected depending on the details and objectives of a particular implementation.

The process described above with respect to FIG. 3 has the effect of front loading wear on the less aged or worn battery. This will tend to equalize the wear and aging as between the two batteries, and therefore improve the life of both batteries. FIG. 4 illustrates a plot of charge versus time for exemplary methods 200 and 300, and illustrates the different timing of the two methods.

Solid line 405 illustrates the first battery's charge versus time for exemplary method 200, and solid lines 410 and 420 illustrate the second battery's charge versus time when implementing the method described above with reference to FIG. 2. More specifically, both batteries begin at time T0 in a fully charged state. As described above, each battery is powering the loads associated with itself, e.g., the battery in each ear cup is powering the loads in that ear cup, and thus the first battery, which has a higher load, discharges more quickly (as indicated by solid line 405). During that same interval, the second battery discharges mores slowly (because of the lower load) as indicated by solid line 410. At time T2, the first battery is completely discharged, and the second battery begins to power both loads. As a result, the second battery discharges more quickly, as indicated by solid line 420.

As noted above, the process described above with respect to FIG. 3 can be used in conjunction with the process described with respect to FIG. 2 to front load an increased load on the lesser worn or aged battery (e.g., the second battery). Dashed lines 430 and 440 show the second battery's charge over time for method 300, while dashed lines 415 and 425 show the first battery's charge versus time for method 300. More specifically, at time T0 both batteries are fully charged. Initially, both loads are powered from the second battery (i.e., the less used or worn battery), resulting in a relatively higher discharge rate as indicated by line 430. During that same time period, the first battery (i.e., the more used or worn battery) is not discharged, as indicated by line 415. At time T1, the system reaches the threshold where it returns to having each battery power its own respective devices. At that point the first battery discharges as indicated in dashed line 425, while the second battery discharges at the rate indicated by dashed line 440, until both batteries are completely discharged at time T4. (All of the foregoing assumes that the user does not charge the batteries before reaching full discharge/time T4).

The systems and devices herein may be used in conjunction with any type of electronic devices, including for example, battery powered portable computing devices and associated peripherals. Such battery powered computing devices may include laptop computers, tablet computers, smart phones, media players. Such associated peripherals can include input devices (such as keyboards, mice, touchpads, tablets, and the like), output devices (such as headphones or speakers), storage devices, or any other peripheral having a connection that allows for communication and power exchange between the respective battery powered electronic devices. Additionally, the systems and techniques described herein need not be limited to systems comprising two battery powered devices, but may be used in connection with systems including three or more battery powered devices that operate together. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A headphone comprising:
a first ear cup having disposed therein a first battery, a first power converter coupled to the first battery, and a first plurality of electronic components coupled to the first power converter;
a second ear cup having disposed therein a second battery, a second power converter coupled to the second battery, and a second plurality of electronic components coupled to the second power converter;
a connection between the first ear cup and the second ear cup, the connection further comprising at least one current path between the first power converter in the first ear cup and the second power converter in the second ear cup; and
a microcontroller coupled to the first and second power converters and configured to selectively control the first and second power converters to:
power the first plurality of electronic components from the first battery via the first power converter;
power the second plurality of electronic components from the second battery via the second power converter;
power the first plurality of electronic components from the second battery via the at least one current path and at least one of the first and second power converters; and
power the second plurality of electronic components from the first battery via the at least one current path and the one or more of the first and second power converters.

2. The headphone of claim 1 wherein the microcontroller is coupled to the first and second power converters via the connection between the first ear cup and the second ear cup.

3. The headphone of claim 1 wherein the microcontroller is coupled to the first and second power converters via a wireless transceiver.

4. The headphone of claim 1 wherein the microcontroller is located in the first ear cup.

5. The headphone of claim 1 wherein the connection is a headband.

6. The headphone of claim 1 wherein the microcontroller comprises two cooperating microcontrollers, a first cooperating microcontroller located in the first ear cup, and a second cooperating microcontroller located in the second ear cup.

7. The headphone of claim 6 wherein the two cooperating microcontrollers are coupled via a wired link through the connection between the first ear cup and the second ear cup.

8. The headphone of claim 6 wherein the two cooperating microcontrollers are coupled via a wireless transceiver.

9. The headphone of claim 1 further comprising a charging port coupled to the first and second power converters.

10. The headphone of claim 1 wherein the charging port is coupled to the first and second power converters via the connection between the first ear cup and the second ear cup.

11. The headphone of claim 9 wherein the charging port is coupled to at least one of the first and second power converters via the at least one current path disposed within the connection.

12. The headphone of claim 1 wherein the first plurality of electronic components comprises a wireless transceiver.

13. The headphone of claim 1 wherein the first battery and the second battery have the same form factor and rated capacity.

14. A method of controlling battery discharging in an electronic device, the electronic device comprising a first member having disposed therein a first battery, a first power converter coupled to the battery, and one or more first electronic devices coupled to the first power converter, a second member having disposed therein a second battery, a second power converter coupled to the second battery, and one or more second electronic devices coupled to the second power converter, and at least one current path between the first power converter and the second power converter, the method comprising:
determining whether the first battery has sufficient charge to power the one or more first electronic devices;
determining whether the second battery has sufficient charge to power the one or more second electronic devices;
responsive to determinations that the first battery has sufficient charge to power the one or more first electronic devices and that the second battery has sufficient charge to power the one or more second electronic devices:
operating the first power converter to power the one or more first electronic devices from the first battery; and
operating the second power converter to power the one or more second electronic devices from the second battery; and
responsive to a determination that the first battery does not have sufficient charge to power the one or more first electronic devices:
causing the second battery to provide power to the one or more first electronic devices via the at least one current path.

15. The method of claim 14 further comprising:
determining whether an age difference between the first battery and the second battery meets a predetermined threshold; and
responsive to a determination that the age difference meets the predetermined threshold:
operating the second power converter to provide power from the second battery to the one or more second electronic devices and to the first power converter via the at least one current path;
operating the first power converter to power the one or more first electronic devices from the at least one current path;
determining whether the second battery has sufficient charge to continue powering the one or more first and one or more second electronic devices; and
responsive to a determination that the second battery does not have sufficient charge to continue powering the one or more first and one or more second electronic devices:
providing power from the first battery to the one or more first electronic devices and the one or more second electronic devices via the at least one current path.

16. The method of claim 14 wherein determining whether the age difference between the first battery and the second battery meets the age threshold further comprises comparing a nominal capacity of the first battery to a nominal capacity of the second battery.

17. The method of claim 14 wherein determining whether the age difference between the first battery and the second battery meets the age threshold further comprises comparing a cycle count of the first battery to a cycle count of the second battery.

18. An apparatus comprising:
a first electronic subsystem comprising a first battery, a first power converter coupled to the first battery, and a first load coupled to the first power converter;
a second electronic subsystem comprising a second battery, a second power converter coupled to the second battery, and a second load coupled to the second power converter;
at least one current path between the first and the second electronic subsystems; and
a controller coupled to the first and second power converters and configured to selectively control the first and second power converters to:
power the first load from the first battery via the first power converter;
power the second load from the second battery via the second power converter;
power the first load from the second battery via the at least one current path and one or more of the first and second power converters; and
power the second load from the first battery the at least one current path and one or more of the first and second power converters;
wherein the controller selectively controls the first and second power converters based at least in part on a condition of at least one of the first and second batteries' state of charge.

19. The apparatus of claim 18 wherein the controller is coupled to the first and second power converters via the at least one current path.

20. The apparatus of claim 18 wherein the controller is coupled to the first and second power converters by a wireless transceiver.

21. The apparatus of claim 18 wherein the controller is located in the first electronic sub system.

22. The apparatus of claim 18 wherein the controller is located in a third electronic subsystem.

23. The apparatus of claim 18 wherein the controller comprises two cooperating controllers, a first cooperating controller located in the first electronic subsystem, and a second cooperating controller located in the second electronic subsystem.

24. The apparatus of claim 23, wherein the controller further comprises a third cooperating microcontroller located in a third electronic subsystem.

25. The apparatus of claim 13 further comprising a charging port coupled to the first and second power converters.

26. The apparatus of claim 13 wherein the charging port is coupled to the first and second power converters via the connection between the first ear cup and the second ear cup.

27. The apparatus of claim 18 wherein the charging port is coupled to at least one of the first and second power converters via the at least one current path.

28. The apparatus of claim 13 wherein the first load comprises a wireless transceiver.
